(19) United States
(12) Patent Application Publication
(10) Pub. No.: US 2009/0116722 A1
(43) Pub. Date: May 7, 2009

(54) Method and system for soft tissue image reconstruction in gradient domain

(76) Inventors: Yunqiang Chen, Plainsboro, NJ (US); Tong Fang, Morganville, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/287,551

(22) Filed: Oct. 10, 2008

Related U.S. Application Data
(60) Provisional application No. 60/982,491, filed on Oct. 25, 2007.

(51) Int. Cl. H05G 1/64; G06K 9/00

(52) U.S. Cl. 382/132; 378/98.9

(57) ABSTRACT

A method and system for soft tissue image reconstruction for dual x-ray imaging is disclosed. A multigrid PDE solver is used for solving a Poisson equation for soft tissue image reconstruction based on a soft tissue gradient field extracted from dual energy x-ray images. The divergence of the soft tissue gradient field is downsampled to a coarsest resolution level, and a soft tissue image is generated based on the divergence of the soft tissue gradient field at the coarsest level. The soft tissue image is interpolated to a next finest resolution level, and refined by at least one coarse grid correction cycle at the current resolution level. The coarse grid correction cycle calculates a defect based on the current soft tissue image, downsamples the defect to the coarsest level, calculates a correction based on the defect at the coarsest level, and upsamples the correction to the current resolution level to refine the current soft tissue image. The interpolation and refinement of the soft tissue image is repeated until the soft tissue image is refined at the finest resolution level.

This application claims the benefit of U.S. Provisional Application No. 60/982,491, filed Oct. 25, 2007, the disclosure of which is herein incorporated by reference.

### BACKGROUND OF THE INVENTION

The present invention relates to dual image x-ray imaging, and more particularly, to soft tissue image reconstruction in dual energy imaging.

High energy photons, like x-rays, which can pass through objects before being absorbed, are widely used in security, medical imaging, and industrial applications. Unlike in normal images, in x-ray images, 3D objects are projected into 2D images and appear semi-transparent. In dual energy x-ray imaging, two images are acquired with x-rays at high and low energy spectra. Due to different attenuation coefficients of bone and soft tissue, it is possible to separate different layers for bone and soft tissue from these dual energy images, to allow more accurate inspection of the bone and soft tissue regions in the x-ray images. In chest x-ray imaging, the dual energy images can be formulated as I₁=a·B+b·S and I₂=c·B+d·S if there is no motion during the acquisition of I₁ and I₂. Constants a, b, c, and d reflect the attenuation coefficients of the bone (B) and soft tissue (S) to the high and low x-ray spectra. The two layers (B and S) can then be individually reconstructed by weighted subtraction between I₁ and I₂.

Although some motion can be prevented while acquiring the dual energy x-ray images (e.g., holding breath to stop rib motion), some motion is inevitable (e.g., heart beating). For a more realistic model, it can be assumed that one layer (e.g., bone) is static or its motion has been compensated, but the other layer (e.g., soft tissue) has different motion. The image formation model considering such motion is defined as:

I₁=a·B+b·S

I₂=c·B+d·T_{S}(S) (1)

where T_{S}(s) is the relative soft tissue motion after compensating the bone motion. Weighted subtraction cannot be used to reconstruct the layers in this case, since weighted subtraction generates artifacts due to the motion. In order to reconstruct the soft tissue image where motion is observed, inpainting is used. Inpainting is implemented by solving a Poisson equation whose right side is the divergence of the modified high-dose gradient of the soft tissue ∇· ∇̅H̅. In ∇̅H̅, the bone gradient components have already been removed. Although a mask is made to restrict the inpainting inside the motion region, the Poisson equation can still be very large since the input image can have millions of pixels. Traditional relaxation-based solvers are typically used to solve this Poisson equation. However, the convergence speed for solving this Poisson equation using the traditional relaxation-based solvers is very slow. Therefore, a more efficient method for soft tissue image reconstruction is desirable.

### BRIEF SUMMARY OF THE INVENTION

The present invention provides a method and system for soft tissue image reconstruction for dual energy x-ray imaging. Embodiments of the present invention utilize a multigrid method for solving partial differential equations (PDE) to solve the Poisson equation for soft tissue image reconstruction. Since it is difficult to apply the multigrid method to irregular domains, embodiments of the present invention setup Poisson equation for a rectangular range including static and motions regions of dual energy x-ray images.

In one embodiment of the present invention, a soft tissue image is reconstructed based on a soft tissue gradient field extracted from dual energy x-ray images. The divergence of the soft tissue gradient field is downsampled to a coarsest resolution level, and a soft tissue image is generated based on the divergence of the soft tissue gradient field at the coarsest level. The soft tissue image is interpolated to a next finest resolution level, and refined by at least one coarse grid correction cycle at the current resolution level. The coarse grid correction cycle calculates a defect based on the current soft tissue image, downsamples the defect to the coarsest level, calculates a correction based on the defect at the coarsest level, and upsamples the correction to the current resolution level to refine the current soft tissue image. The interpolation and refinement of the soft tissue image is repeated until the soft tissue image is refined at the finest resolution level.

In another embodiment of the present invention, first and second dual energy images are received. A gradient field is extracted from the first dual energy image, and a soft tissue gradient field is generated by removing bone gradients. A soft tissue image is reconstructed by using a multigrid method to solve a Poisson equation for the soft tissue image based on a Laplacian operator on the soft tissue image and a divergence of the soft tissue gradient field.

These and other advantages of the invention will be apparent to those of ordinary skill in the art by reference to the following detailed description and the accompanying drawings.

### BRIEF DESCRIPTION OF THE DRAWINGS

FIG. 1 illustrates a method for dual energy imaging according to an embodiment of the present invention;

FIG. 2 illustrates a multigrid method for soft tissue image reconstruction according to an embodiment of the present invention;

FIG. 3 illustrates a method for performing a coarse grid correction cycle according to an embodiment of the present invention;

FIG. 4 illustrates a structure of a coarse grid correction cycle;

FIG. 5 illustrates a structure of the full multigrid method;

FIG. 6 illustrates the setup of the Poisson equation using a rectangular domain;

FIG. 7 illustrates exemplary results of soft tissue image reconstruction using the methods of FIGS. 1, 2, and 3; and

FIG. 8 is a high level block diagram of a computer capable of implementing the present invention.

### DETAILED DESCRIPTION

The present invention relates to a method and system for soft tissue image reconstruction for dual energy x-ray imaging. Embodiments of the present invention are described herein to give a visual understanding of the soft tissue image reconstruction method. A digital image is often composed of digital representations of one or more objects (or shapes). The digital representation of an object is often described herein in terms of identifying and manipulating the objects. Such manipulations are virtual manipulations accomplished in the memory or other circuitry/hardware of a computer system. Accordingly, is to be understood that embodiments of the present invention may be performed within a computer system using data stored within the computer system.

Embodiments of the present invention utilize a multigrid method to reconstruct a soft tissue image from a soft tissue gradient extracted from dual energy x-ray images. Instead of decomposing intensity values in dual energy x-ray images, the gradient is decomposed into different layers, and bone and soft-tissue images can be reconstructed using separated gradient fields by solving a Poisson equation. The Poisson equation is solved using a multigrid method that estimates an initial solution at a coarser resolution, and iteratively refines the solution at finer resolutions.

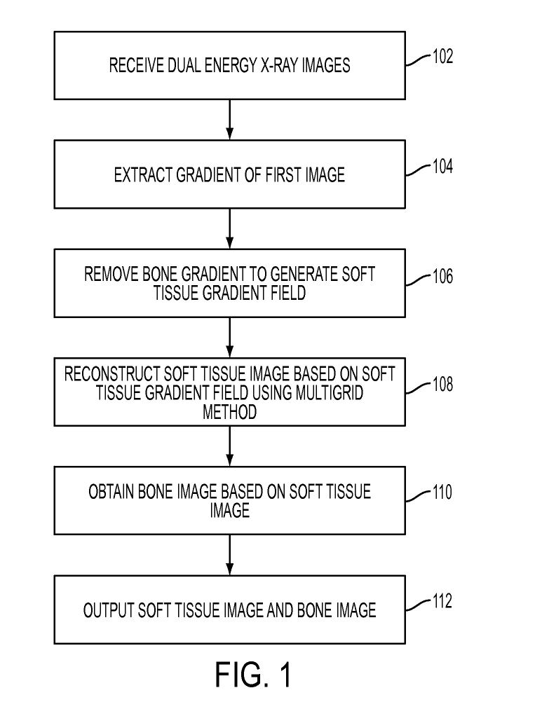

FIG. 1 illustrates a method for dual energy imaging according to an embodiment of the present invention. As illustrated in FIG. 1, at step 102, dual energy x-ray images are received. In particular, first and second images, which are X-ray images acquired at low and high energy levels, respectively, are received. The first and second images can be received via an image acquisition device, such as an X-ray imaging device. The first and second images (I₁ and I₂) may be acquired by the image acquisition device performing a well-known dual energy imaging procedure. It is also possible that the first and second images be acquired in advance of the method, stored in a computer readable medium or a storage or memory of a computer system performing the steps of the method, and received by loading the images from the memory or storage of the computer system.

At step 104, the gradient of the first image (i.e., the high energy image) I₁ is extracted. Since gradient features are sparse, the gradient ∇I₁ is almost the same as the soft tissue gradient for most pixels of I₁, except for regions that have bone boundaries. Since ∇I₁=a·∇B+b·∇S, for gradient regions that have no bone boundaries, the soft tissue gradient can be obtained from one image, as ∇S=∇I₁/b. In regions that have bone boundaries, the soft tissue gradient and bone gradient usually have different orientations, hence allowing better decomposition. For the regions that have bone boundaries, the bone gradients are aligned between the dual energy images according to Equation (1). Accordingly, these regions can be detected utilizing ∇I₁ and ∇I₂.

At step 106, the bone gradient is removed from the gradient of the first image in order to generate the soft tissue gradient field. According to Equation (1), the bone gradient should appear in both I₁ and I₂ at the same location along the same orientation. Therefore, for regions that have bone boundaries, the gradients ∇I₁ and ∇I₂ have a ratio of approximately a/c. For regions dominated by the soft tissue gradient, the ratio is around b/d if there is no soft tissue motion, and the ratio can be arbitrary if the soft tissue has moved. This provides an important cue to discriminate bone and soft tissue gradients. This concept used with a structure tensor can detect the existence and estimate the orientation of bone boundaries.

The structure tensor is a 2×2 matrix that can be estimated from a set of oriented quadrature filters as follows:

$$T = {\sum }_{k} ‖ {q}_{k} ‖ ( {n}_{k} {n}_{k}^{T} - α I ) , \qquad ( 2 )$$

where qₖ is the output from quadrature filter k and nₖ is the orientation vector of the quadrature filter k. I is the identity tensor and α is a constant depending on tensor dimension. In order to detect the existence of a bone gradient for removal, it is estimated if the quadrature filter output is from a bone gradient or not. If the oriented quadrature filter output on image I₁ (i.e., q_{k,1}) and image I₂ (i.e., q_{k,2}) have a given ration (i.e., q_{k,1}/(q_{k,1}+q_{k,2})≈a/(a+c)), it indicates that the filter output is mainly from a bone gradient. Assuming the ration is corrupted by Gaussian distributed noise, the probability that the quadrature filter output belongs to bone boundaries is given as follows:

$${P}_{B , k} = \frac{1}{σ \sqrt{2 π}} {e}^{- {( \frac{{q}_{k , 1}}{( {q}_{k , 1} + {q}_{k , 2} )} - \frac{a}{( a + c )} )}^{2} / \text{(} 2 {σ}^{2} \text{)}} . \qquad ( 3 )$$

Accordingly, the tensor defined in Equation (2) can be modified as follows to represent a bone gradient tensor:

$$T = {\sum }_{k} {P}_{B , k} \cdot ‖ {q}_{k , 1} ‖ ( {n}_{k} {n}_{k}^{T} - α I ) . \qquad ( 4 )$$

The eigenvalues of the tensor matrix (i.e., λ₁ and λ₂) can be calculated. If there are bone boundaries in the neighborhood, the eigenvalues are larger. Thus, the regions that contain bone boundaries can be detected by thresholding on λ₁²+λ₂² for further bone gradient removal.

For the regions that contain bone gradients, it is possible that they also contain soft tissue gradients. Accordingly, the bone gradient must be separated from the soft tissue gradient. The structure tensor, which is used to detect the bone gradient, can also be used to estimate the bone gradient orientation. The bone boundary orientation can be calculated by θ=arctan(2I₁₂/(I₂₂−I₁₁+C)). To remove bone gradient, the gradient vector (i.e., ∇I₁) is projected to the angle that is parallel to the bone boundaries (i.e., n_{θ}). Accordingly, the soft tissue gradient field calculation can be expressed as:

$$∇ S = \{ \begin{matrix} ∇ {I}_{1} , & if {λ}_{1}^{2} + {λ}_{2}^{2} < {C}_{thres} \\ 〈 ∇ {I}_{1} , {n}_{θ} 〉 \cdot {n}_{θ} , & if {λ}_{1}^{2} + {λ}_{2}^{2} \geq {C}_{thres} .\end{matrix} \qquad ( 5 )$$

At step 108, the soft tissue image is reconstructed based on the soft tissue gradient field. Given the gradient field of the soft tissue layer, G=∇S, a soft tissue image S is reconstructed whose gradient field is closest to G. One natural way to achieve this is to solve the equation ∇Ŝ=G. However, since the original gradient field is modified, the resulting gradient field is not necessarily integrable. Some part of the modified gradient may violate ∇×G=0 (i.e., the curl of the gradient is 0). In such a case, the potential function Ŝ must be determined such that its gradients are closest to G in the sense of least square by searching the space of all 2D potential function, that is, to minimize the following integral in 2D space:

f=min∫∫F(∇Ŝ,G)dxdy (6)

where F(∇Ŝ,G)=∥∇Ŝ−G∥². According to the Variational Principle, a function F that minimizes the integral must satisfy the Euler-Lagrange equation:

$$\frac{\partial F}{\partial \hat{S}} - \frac{d}{d x} \frac{\partial F}{\partial \hat{S}} - \frac{d}{d y} \frac{\partial F}{\partial \hat{S}} = 0. \qquad ( 7 )$$

A 2D Poisson equation can then be derived, as follows:

∇²Ŝ=∇·G (8)

where ∇² is the Laplacian operator,

$${∇}^{2} \hat{S} = \frac{{\partial }^{2} \hat{S}}{\partial {x}^{2}} + \frac{{\partial }^{2} \hat{S}}{\partial {y}^{2}}$$

and ∇·G is the divergence of the vector field G, which is defined as

$$∇ \cdot G = \frac{\partial {G}_{x}}{\partial x} + \frac{\partial {G}_{y}}{\partial y} .$$

In order to solve the Poisson equation (Equation (8)), we can use the Neumann boundary conditions Ŝ·\vec{n}=0, where n is the normal on the boundary Ω. In this case, the intensity gradients can be approximated by the forward difference:

∇Ŝ=[Ŝ(x+1,y)−Ŝ(x,y),Ŝ(x,y+1)−Ŝ(x,y)]^{T},

and the Laplacian is represented as:

∇²Ŝ=−4Ŝ(x,y)+Ŝ(x−1,y)+Ŝ(x+1,y)+Ŝ(x,y+1)+Ŝ(x,y−1).

The divergence of the gradient can be approximated as:

∇·G=Gₓ(x,y)−Gₓ(x−1,y)+G_{y}(x,y)−G_{y}(x,y−1).

The Poisson equation of Equation (8) results in a large system of linear equations. The Poisson equation can be thought of as a linear elliptic problem Lu=f where u represents the soft tissue image (Ŝ), L represents the Laplacian operator (∇²), and f represents the divergence of the soft tissue gradient field (∇·G). When trying to solve the linear elliptical problem Lu=f on a uniform grid with mesh size (i.e., image size) h, the discretized equation is expressed as:

Lₕuₕ=fₕ. (9)

Iterant solvers assume an initial solution uₕ⁰ and iteratively refine the solution by solving the defect equation:

Lₕvₕ=−dₕ, (10)

where vₕ=uₕ−uₕ⁰ and dₕ=Lₕuₕ⁰−fₕ. The defect dₕ measures the accuracy of the initial solution, and is used to calculate a correction vₕ to refine the initial solution.

Conventional relaxation methods, such as Jacobi or Gauss-Seidel, solve an approximate simplified defect equation:

Aₕvₕ=−dₕ. (11)

For Jacobi iteration, Aₕ is the diagonal part of Lₕ, and for Gauss-Seidel iteration, Aₕ is the lower triangle part of Lₕ. These conventional relaxation methods correct high frequency error quickly, but suppress low frequency error very slowly.

According to an embodiment of the present invention, the multigrid method coarsifies the defect equation rather than simplifying it. In particular the multigrid method approximates Lₕ at a coarser resolution level with a smaller equation:

L_{H}v_{H}=−d_{H}, (12)

where H is the coarser mesh size (resolution level), such as H=2h. Since Lₕ has smaller dimension, this equation is easier to solve, and it focuses more on a low frequency error. In order to define the defect d_{H} at the coarser resolution, a restriction operator Iₕ^{H}, which downsamples dₕ is defined as:

d_{H}=Iₕ^{H}dₕ. (13)

Once a correction solution v_{H} is obtained at the coarse level, a prolongation operator I_{H}^{h}, which upsamples v_{H} is defined as:

vₕ=I_{H}^{h}v_{H}. (14)

The restriction and prolongation operators satisfy:

I_{H}^{h}Iₕ^{H}=I. (15)

Note that the restriction and prolongation operators are not square matrices. Therefore, the coarse grid operator Lₕ is defined by:

L_{H}=Iₕ^{H}LₕI_{H}^{h}. (16)

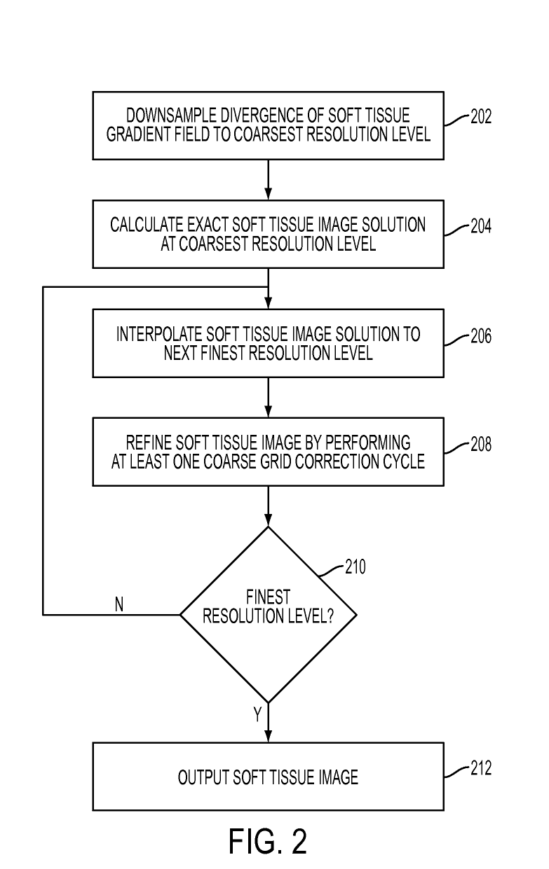

FIG. 2 illustrates a multigrid method for soft tissue image reconstruction according to an embodiment of the present invention. Accordingly, the method of FIG. 2 can be used to implement step 108 of the method of FIG. 1. Although the method of FIG. 2 is described herein as solving the Poisson equation in order to reconstruct a soft tissue image, it is to be understood that the multigrid method of FIG. 2 can be used to solve any partial differential equations (PDEs) which can represented as a linear elliptic problem Lu=f as described above.

Referring to FIG. 2, at step 202, the divergence of the soft tissue gradient field (f) is iteratively downsampled to a coarsest level. At each iteration, the resolution of the divergence of soft tissue gradient field is downsampled by half, until the size becomes small enough to obtain an exact solution for a coarse soft tissue image at that resolution. At step 204, an exact solution is found for a soft tissue image at the coarsest level. At step 206, the current soft tissue image solution is interpolated to a next finest resolution level.

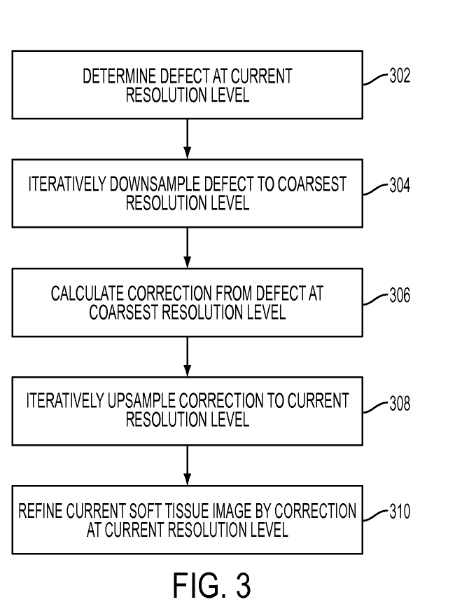

At step 208, the current soft tissue image is refined by performing at least one coarse grid correction cycle. FIG. 3 illustrates a method for performing a coarse grid correction cycle according to an embodiment of the present invention. Accordingly, each coarse grid correction cycle of step 208 of the method of FIG. 2 can be implemented using the method of FIG. 3 According to a possible implementation, the coarse grid correction cycle of FIG. 3 can be performed once or multiple times at a single resolution level. As illustrated in FIG. 3, at step 302, the defect dₕ is determined at the current resolution level based on the current soft tissue image solution uₕ⁰. The defect is determined as dₕ=Lₕuₕ⁰−fₕ. At step 304, the defect is iteratively downsampled to the coarsest level using the restriction operator, as expressed in Equation (13). At each resolution level that the defect is downsampled, the defect can be smoothed. For example, the defect can be smoothed using low-pass filtering. At step 306, a correction solution v_{H} is calculated from the defect d_{H} at the coarsest level. The coarse correction solution is calculated by solving Equation (12). At step 308, the correction solution v_{H} is iteratively upsampled (interpolated) to the current resolution level vₕ using the prolongation operator, as expressed in Equation (14). At each resolution level that the correction solution is upsampled, the correction solution can be smoothed. For example, the correction solution can be smoothed using low-pass filtering. At step 310, the current soft tissue image at the current resolution level is refined by the correction vₕ.

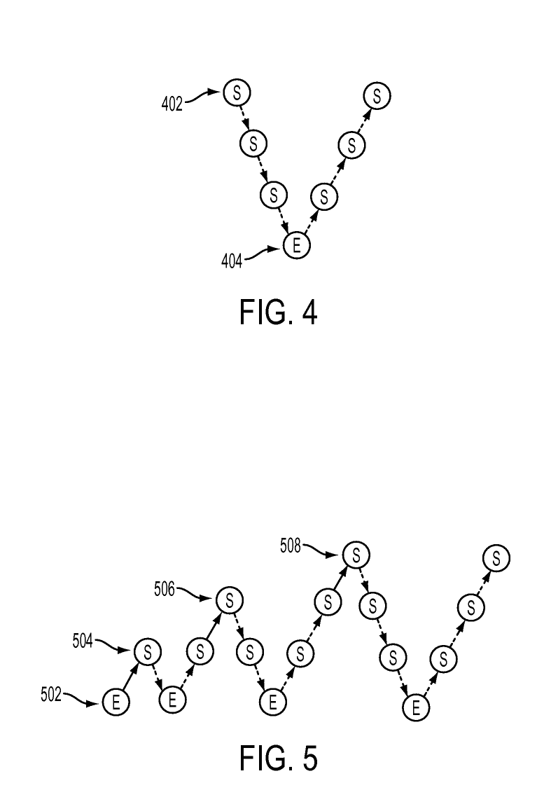

FIG. 4 illustrates a structure of a coarse grid correction cycle. As illustrated in FIG. 4, “S” denotes smoothing and “E” denotes an exact solution at the coarsest resolution level. The dashed arrows represent defect restriction (downsampling) to a coarser resolution level or correction prolongation (upsampling) to a finer resolution level. As shown in FIG. 4, the defect, starting at a current (finest) resolution level 402 is iteratively downsampled and smoothed to a coarsest resolution level 404, where the correction is calculated. The correction is then iteratively upsampled and smoothed from the coarsest resolution level 404 to the current (finest) resolution level 402, where it is used to refine the current solution.

Returning to FIG. 2, at step 210, it is determined whether the current resolution level is the finest (or original) resolution level. If the current resolution level is not the finest resolution level, the method returns to step 206, and interpolates the current soft tissue image to a next finest resolution level, where it is refined using at least one coarse grid correction cycle (step 208). Accordingly, steps 206 and 208 are repeated until a soft tissue image is interpolated and refined at a finest resolution level. If the current resolution level is the finest resolution level, the method proceeds to step 212.

At step 212, the soft tissue image is output. The output soft tissue image was interpolated to the finest resolution level, and refined by at least one coarse grid correction cycle at the finest resolution level. The soft tissue image can be output by displaying the soft tissue image, for example on a display of a computer system. The soft tissue image can also be output by storing the soft-tissue image, for example, in a computer readable medium, storage, or memory of a computer system. The soft tissue is used in the dual energy imaging method of FIG. 1 to obtain the bone image.

The multigrid method of FIG. 2 can be referred to as the Full Multigrid (FMG) method. FIG. 5 illustrates a structure of the FMG method. As illustrated in FIG. 5, “S” denotes smoothing and “E” denotes an exact solution at the coarsest resolution level. Solid arrows denote restriction (downsampling) and prolongation of the original equations (i.e., f and u), and dashed arrows denote restriction (downsampling) and prolongation (upsampling) of the defect equations (i.e. defect and correction). As shown in FIG. 5, starting with an exact solution for f at a coarsest level 502, the FMG method interpolates the solution to resolution levels 504, 506, and 508 (finest resolution). At each of the resolution levels 504, 506, and 508 the solution is refined by a coarse grid correction cycle. Note that it is possible that multiple coarse grid correction cycles be used at each resolution, but in FIG. 5, a single coarse grid correction cycle is used at each resolution.

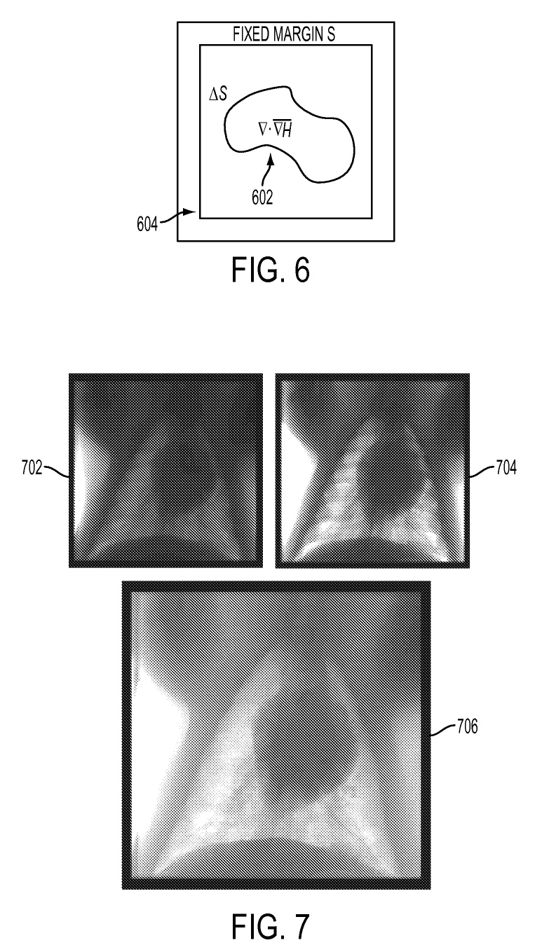

It is non-trivial to apply the FMG method to an irregular domain because the boundary may not be downsampled correctly, which can prevent convergence. To solve this problem, the irregular domain Ω is expanded into a rectangle R that occupies the whole image except for some marginal pixels. In Ω, the right hand side is still defined as the divergence of the modified gradient of the high dose (high energy) image, while in R\Ω, the Laplacian of the subtracted image in specified where linear subtraction works well. In this way, the FMG method can be applied to a domain of arbitrary shape. The pixels in R\Ω are no longer fixed strictly, but are still very similar to those in the subtracted image. FIG. 6 illustrates the setup of the Poisson equation using a rectangular domain. As illustrated in FIG. 6, although the modified gradient domain ∇· ∇̅H̅ (602) has an irregular shape, the equation domain 604 is defined by ΔS, which has a rectangular shape defined by a fixe margin for the soft tissue image S.

Returning to FIG. 1, at step 110, the bone image is obtained based on the reconstructed soft tissue image. The bone image can be obtained by subtraction between the high energy image I₁ and the reconstructed soft tissue image.

At step 112, the soft tissue image and the bone image are output. The soft tissue and bone images can be output by displaying the soft tissue image, for example on a display of a computer system. The soft tissue and bone images can also be output by storing the soft-tissue image, for example, in a computer readable medium, storage, or memory of a computer system.

FIG. 7 illustrates exemplary results of soft tissue image reconstruction using the methods of FIGS. 1, 2, and 3. As illustrated in FIG. 7, images 702 and 704 are dual energy images. Image 702 is a high energy image and image 704 is a low energy image. Image 706 is a soft tissue image generated from the dual energy images 702 and 704 using dual energy imaging with soft tissue image reconstruction using the FGM method, as described in FIGS. 1, 2, and 3.

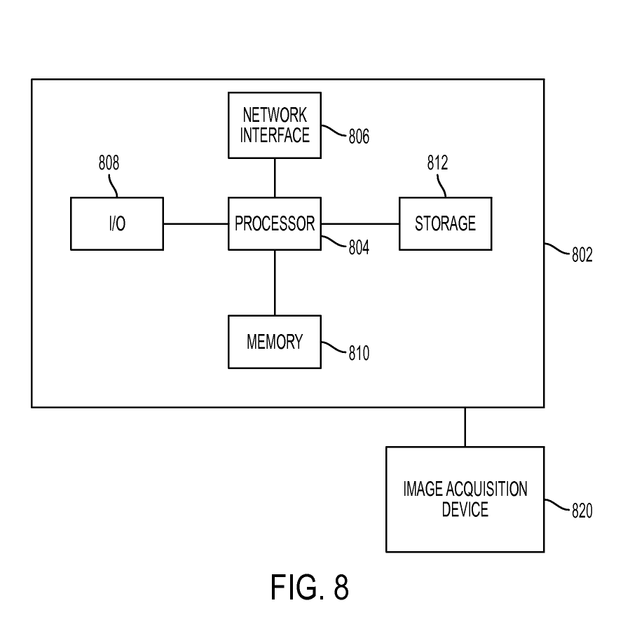

The above-described methods for dual energy imaging and soft tissue image reconstruction may be implemented on a computer using well-known computer processors, memory units, storage devices, computer software, and other components. A high level block diagram of such a computer is illustrated in FIG. 8. Computer 802 contains a processor 804 which controls the overall operation of the computer 802 by executing computer program instructions which define such operation. The computer program instructions may be stored in a storage device 812, or other computer readable medium, (e.g., magnetic disk) and loaded into memory 810 when execution of the computer program instructions is desired. Thus, all method steps described above for dual energy imaging and soft tissue image reconstruction, including the method steps illustrated in FIGS. 1, 2 and 3, may be defined by the computer program instructions stored in the memory 810 and/or storage 812 and controlled by the processor 804 executing the computer program instructions. An image acquisition device 820, such as an X-ray imaging device, can be connected to the computer 802 to input images to the computer 802. It is possible to implement the image acquisition device 820 and the computer 802 as one device. It is also possible that the image acquisition device 820 and the computer 802 communicate wirelessly through a network. The computer 802 also includes one or more network interfaces 806 for communicating with other devices via a network. The computer 802 also includes other input/output devices 808 that enable user interaction with the computer 802 (e.g., display, keyboard, mouse, speakers, buttons, etc.) One skilled in the art will recognize that an implementation of an actual computer could contain other components as well, and that FIG. 8 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for reconstructing a soft tissue image from a soft tissue gradient field extracted from dual energy x-ray images, comprising:
(a) downsampling a divergence of the soft tissue gradient field to a coarsest resolution level;
(b) generating a soft tissue image based on the divergence of the soft tissue gradient field at the coarsest resolution level;
(c) interpolating the soft tissue image to a next finest resolution level;
(d) refining the soft tissue image by performing at least one coarse grid correction cycle; and
(e) repeating steps (c) and (d) until the soft tissue image is refined at a finest resolution level.

2. The method of claim 1, wherein step (b) comprises:
determining a soft tissue image at the coarsest level that is an exact solution to a Poisson equation based on the divergence of the soft tissue gradient field at the coarsest level and an estimate of a Laplacian operator at the coarsest level.

3. The method of claim 1, wherein step (d) comprises:
determining a defect at a current resolution level based on the soft tissue image at the current resolution level;
iteratively downsampling the defect to the coarsest resolution level;
calculating a correction based on the defect at the coarsest resolution level;
iteratively upsampling the correction to the current resolution level; and
refining the soft tissue image at the current resolution level by the upsampled correction.

4. The method of claim 3, wherein said step of determining a defect at a current resolution level comprises:
calculating the defect between the divergence of the soft tissue gradient field extracted from dual energy x-ray images and a divergence of the soft tissue gradient field calculated based on the soft tissue image at the current resolution level.

5. The method of claim 3, wherein said step of iteratively downsampling the defect to the coarsest resolution level comprises:
iteratively downsampling the defect to the coarsest resolution level using a restriction operator; and
smoothing the downsampled defect at each iteration.

6. The method of claim 3, wherein said step of iteratively upsampling the correction to the current resolution level comprises:
iteratively upsampling the correction to the current resolution level using a prolongation operator; and
smoothing the upsampled defect at each iteration.

7. The method of claim 1, wherein step (d) comprises:
refining the soft tissue image multiple times using multiple coarse grid correction cycles at a current resolution level.

8. The method of claim 1, wherein the soft tissue image has a rectangular domain.

9. A method for dual energy x-ray imaging, comprising:
receiving first and second x-ray images acquired at high and low energy spectra, respectively;
extracting a gradient field of the first x-ray image;
generating a soft tissue gradient field by removing bone gradients from the gradient field of the first x-ray image based on gradient fields of the first and second x-ray images; and
generating a soft tissue image by reconstructing the soft tissue image from the soft tissue gradient field using a multigrid method to solve a Poisson equation for the soft tissue image based on a Laplacian operator on the soft tissue image and a divergence of the soft tissue gradient field.

10. The method of claim 9, wherein said step of generating a soft tissue image by reconstructing the soft tissue image from the soft tissue gradient field comprises:
(a) downsampling the divergence of the soft tissue gradient field to a coarsest resolution level;
(b) generating a soft tissue image by solving the Poisson equation based on the divergence of the soft tissue gradient field at the coarsest resolution level;
(c) interpolating the soft tissue image to a next finest resolution level;
(d) refining the soft tissue image by performing at least one coarse grid correction cycle; and
(e) repeating steps (c) and (d) until the soft tissue image is refined at a finest resolution level.

11. The method of claim 10, wherein step (d) comprises:
determining a defect at a current resolution level based on the soft tissue image at the current resolution level;
iteratively downsampling the defect to the coarsest resolution level;
calculating a correction based on the defect at the coarsest resolution level;
iteratively upsampling the correction to the current resolution level; and
refining the soft tissue image at the current resolution level by the upsampled correction.

12. The method of claim 9, further comprising:
generating a bone image based on the reconstructed soft tissue image.

13. An apparatus for reconstructing a soft tissue image from a soft tissue gradient field extracted from dual energy x-ray images, comprising:
means for downsampling a divergence of the soft tissue gradient field to a coarsest resolution level;
means for generating a soft tissue image based on the divergence of the soft tissue gradient field at the coarsest resolution level; and
means for iteratively interpolating the soft tissue image to a next finest resolution level and refining the soft tissue image by performing at least one coarse grid correction cycle at the next finest resolution level, until the soft tissue image is refined at a finest resolution level.

14. The apparatus of claim 13, wherein said means for iteratively interpolating the soft tissue image to a next finest resolution level and refining the soft tissue image by performing at least one coarse grid correction cycle at the next finest resolution level comprises:
means for determining a defect at a current resolution level based on the soft tissue image at the current resolution level;
means for iteratively downsampling the defect to the coarsest resolution level;
means for calculating a correction based on the defect at the coarsest resolution level;
means for iteratively upsampling the correction to the current resolution level; and
means for refining the soft tissue image at the current resolution level by the upsampled correction.

15. The apparatus of claim 14, wherein said means for determining a defect at a current resolution level comprises:
means for calculating the defect between the divergence of the soft tissue gradient field extracted from dual energy x-ray images and a divergence of the soft tissue gradient field calculated based on the soft tissue image at the current resolution level.

16. The apparatus of claim 14, wherein said step of means for iteratively downsampling the defect to the coarsest resolution level comprises:
means for iteratively downsampling the defect to the coarsest resolution level using a restriction operator; and
means for smoothing the downsampled defect at each iteration.

17. The apparatus of claim 14, wherein said means for iteratively upsampling the correction to the current resolution level comprises:
means for iteratively upsampling the correction to the current resolution level using a prolongation operator; and
means for smoothing the upsampled defect at each iteration.

18. An apparatus for dual energy x-ray imaging, comprising:
means for receiving first and second x-ray images acquired at high and low energy spectra, respectively;
means for extracting a gradient field of the first x-ray image;
means for generating a soft tissue gradient field by removing bone gradients from the gradient field of the first x-ray image based on gradient fields of the first and second x-ray images; and
means for generating a soft tissue image by reconstructing the soft tissue image from the soft tissue gradient field using a multigrid method to solve a Poisson equation for the soft tissue image based on a Laplacian operator on the soft tissue image and a divergence of the soft tissue gradient field.

19. The apparatus of claim 18, wherein said means for generating a soft tissue image by reconstructing the soft tissue image from the soft tissue gradient field comprises:
means for downsampling a divergence of the soft tissue gradient field to a coarsest resolution level;
means for generating a soft tissue image based on the divergence of the soft tissue gradient field at the coarsest resolution level; and
means for iteratively interpolating the soft tissue image to a next finest resolution level and refining the soft tissue image by performing at least one coarse grid correction cycle at the next finest resolution level, until the soft tissue image is refined at a finest resolution level.

20. The apparatus of claim 19, wherein said means for iteratively interpolating the soft tissue image to a next finest resolution level and refining the soft tissue image by performing at least one coarse grid correction cycle at the next finest resolution level comprises:
means for determining a defect at a current resolution level based on the soft tissue image at the current resolution level;
means for iteratively downsampling the defect to the coarsest resolution level;
means for calculating a correction based on the defect at the coarsest resolution level;
means for iteratively upsampling the correction to the current resolution level; and
means for refining the soft tissue image at the current resolution level by the upsampled correction.

21. A computer readable medium encode with computer executable instructions for reconstructing a soft tissue image from a soft tissue gradient field extracted from dual energy x-ray images, the computer executable instructions defining steps comprising:
(a) downsampling a divergence of the soft tissue gradient field to a coarsest resolution level;
(b) generating a soft tissue image based on the divergence of the soft tissue gradient field at the coarsest resolution level;
(c) interpolating the soft tissue image to a next finest resolution level;
(d) refining the soft tissue image by performing at least one coarse grid correction cycle; and
(e) repeating steps (c) and (d) until the soft tissue image is refined at a finest resolution level.

22. The computer readable medium of claim 21, wherein the computer executable instructions defining step (d) comprise computer executable instructions defining the steps of:
determining a defect at a current resolution level based on the soft tissue image at the current resolution level;
iteratively downsampling the defect to the coarsest resolution level;
calculating a correction based on the defect at the coarsest resolution level;
iteratively upsampling the correction to the current resolution level; and
refining the soft tissue image at the current resolution level by the upsampled correction.

23. The computer readable medium of claim 22, wherein the computer executable instructions defining the step of determining a defect at a current resolution level comprise computer executable instructions defining the step of:
calculating the defect between the divergence of the soft tissue gradient field extracted from dual energy x-ray images and a divergence of the soft tissue gradient field calculated based on the soft tissue image at the current resolution level.

24. The computer readable medium of claim 22, wherein the computer executable instructions defining the step of iteratively downsampling the defect to the coarsest resolution level comprise computer executable instructions defining the steps of:
iteratively downsampling the defect to the coarsest resolution level using a restriction operator; and
smoothing the downsampled defect at each iteration.

25. The computer readable medium of claim 22, wherein the computer executable instructions defining the step of iteratively upsampling the correction to the current resolution level comprise computer executable instructions defining the steps of:
iteratively upsampling the correction to the current resolution level using a prolongation operator; and
smoothing the upsampled defect at each iteration.

26. A computer readable medium encoded with computer executable instructions for dual energy x-ray imaging, the computer executable instructions defining steps comprising:
receiving first and second x-ray images acquired at high and low energy spectra, respectively;
extracting a gradient field of the first x-ray image;
generating a soft tissue gradient field by removing bone gradients from the gradient field of the first x-ray image based on gradient fields of the first and second x-ray images; and
generating a soft tissue image by reconstructing the soft tissue image from the soft tissue gradient field using a multigrid method to solve a Poisson equation for the soft tissue image based on a Laplacian operator on the soft tissue image and a divergence of the soft tissue gradient field.

27. The computer readable medium of claim 26, wherein the computer executable instructions defining the step of generating a soft tissue image by reconstructing the soft tissue image from the soft tissue gradient field comprise computer executable instructions defining the steps of:
(a) downsampling the divergence of the soft tissue gradient field to a coarsest resolution level;
(b) generating a soft tissue image by solving the Poisson equation based on the divergence of the soft tissue gradient field at the coarsest resolution level;
(c) interpolating the soft tissue image to a next finest resolution level;
(d) refining the soft tissue image by performing at least one coarse grid correction cycle; and
(e) repeating steps (c) and (d) until the soft tissue image is refined at a finest resolution level.

28. The computer readable medium of claim 27, wherein the computer executable instructions defining step (d) comprise computer executable instructions defining the steps of:
determining a defect at a current resolution level based on the soft tissue image at the current resolution level;
iteratively downsampling the defect to the coarsest resolution level;
calculating a correction based on the defect at the coarsest resolution level;
iteratively upsampling the correction to the current resolution level; and
refining the soft tissue image at the current resolution level by the upsampled correction.
